(19) United States
(12) Patent Application Publication
(10) Pub. No.: US 2014/0181495 A1
(43) Pub. Date: Jun. 26, 2014

(54) SYSTEM ON CHIP INCLUDING BOOT SHELL DEBUGGING HARDWARE AND DRIVING METHOD THEREOF

(71) Applicant: SAMSUNG ELECTRONICS CO., LTD., Suwon-si (KR)

(72) Inventors: Young-Gun JANG, Gunpo-si (KR); Kwang-Seol KO, Yongin-si (KR)

(73) Assignee: SAMSUNG ELECTRONICS CO., LTD., Suwon-si (KR)

(21) Appl. No.: 14/098,846

(22) Filed: Dec. 6, 2013

(30) Foreign Application Priority Data
Dec. 26, 2012 (KR) 10-2012-0153407

(51) Int. Cl. G06F 11/22; G06F 9/44

(52) U.S. Cl. CPC G06F 11/22; G06F 9/4401
USPC 713/2

(57) ABSTRACT

A system on chip (SOC) includes a first memory configured to store a primary bootloader for providing an environment in which a boot shell is to be executed; and a processor configured to execute the primary bootloader to initialize hardware. The boot shell includes at least one instruction for debugging the hardware, and the processor executes the boot shell and debugs the hardware before a platform is loaded.

### CROSS-REFERENCE TO RELATED APPLICATION

Korean Patent Application No. 10-2012-0153407, filed on Dec. 26, 2012, and entitled: “System on Chip Including Boot Shell Debugging Hardware and Driving Method Thereof,” is incorporated by reference herein in its entirety.

### BACKGROUND

1. Field

One or more embodiments described herein relate to a system on chip (SOC).

2. Description of Related Art

To support a variety of mobile systems, different platforms (e.g., operating systems) have been developed. Each platform may use a different bootloader. To support these bootloaders, a series of operations are required to be performed before the bootloaders are loaded. Also, because new mobile systems are continuously being released, the hardware used by the mobile systems may be evaluated for compatibility and control. However, under some circumstances, it may be difficult to directly control the hardware of a mobile system after its operating system has been loaded.

### SUMMARY

In accordance with one embodiment a system on chip includes a first memory configured to store a primary bootloader for providing an environment in which a boot shell is to be executed; and a processor configured to execute the primary bootloader to initialize hardware, wherein the boot shell includes at least one instruction for debugging the hardware, and wherein the processor executes the boot shell and debugs the hardware before a platform is loaded.

Also, the SOC may include a first controller configured to control a second memory; and a second controller configured to control a nonvolatile memory, wherein the boot shell is stored in one of the first memory or the nonvolatile memory device, and wherein the nonvolatile memory device stores a pre-secondary bootloader, a plurality of secondary bootloaders, a plurality of platforms corresponding to respective ones of the secondary bootloaders, and an application.

Also, if the boot shell is stored in the first memory, the boot shell may be executed at the first memory, and if the boot shell is stored in the nonvolatile memory device, the boot shell may be transferred to the first memory and is executed at the first memory.

Also, the at least one instruction for debugging the hardware may include an instruction for changing data stored in the second memory and an instruction for controlling the hardware. The nonvolatile memory device may include a hard disk drive (HDD), an optical disk drive (ODD), a solid state drive (SSD), a multi-media card (MMC), an embedded multi-media card (eMMC), or a secure digital card.

Also, the pre-secondary bootloader may initializes the second memory and may control the secondary bootloader to be loaded to the second memory. The secondary bootloader may control the platform to be loaded to the second memory.

Also, the boot shell may include at least one instruction for supporting multi-booting, the instruction for supporting multi-booting including a load/store instruction to read or write at least one of the secondary bootloader, the platform, or the application, and a get/set instruction to load or set an environment variable for setting multi-booting.

Also, the hardware may include at least one of the second memory, the nonvolatile memory device, a display device, or a sound device. The platform may include at least one type of operating system.

In accordance with another embodiment, a system on chip includes a first memory to store a primary bootloader and a boot shell; and a processor to initialize an off-chip hardware device by executing the primary bootloader to control an authority of the boot shell or to locate a booting device, and executing at least one instruction in the bootshell to debug the off-chip hardware or to perform a multibooting operation before loading of an operating system.

Also, the bootshell may include at least one instruction to be executed in a first mode and at least one instruction to be executed in a second mode, and the processor may execute the at least one instruction in the first mode to debug the off-chip hardware before an operating system is loaded. The second mode may be a boot mode. The processor may change from the second mode as a default mode to the first mode based on a user signal.

Also, the system on chip may include a second memory to store a pre-secondary bootloader received from an off-chip source, wherein the processor executes the pre-secondary bootloader to control transfer of a secondary bootloader from the off-chip source to the second memory for initializing the off-chip hardware, and wherein the second memory receives an application from the off-chip source to verify the off-chip hardware after transfer of the secondary bootloader into the second memory.

In accordance with another embodiment, a method of driving a system on chip includes executing a primary bootloader to initialize hardware; executing a boot shell; determining whether a current state is a debug mode; and debugging the hardware if the current state is the debug mode, wherein the boot shell stores at least one instruction for debugging the hardware. The method may further include setting an authority of the boot shell and searching for a booting device.

Also, debugging may include executing at least one instruction to adjust a setting value to control an operation of the hardware.

Also, the method may include executing a multi-booting operation if the current state is not the debug mode. Executing the multi-booting operation may include executing a load/store instruction to read or write one of the secondary bootloader, the platform, or the application, and a get/set instruction to load or set an environment variable for setting the multi-booting operation.

### BRIEF DESCRIPTION OF THE DRAWINGS

Features will become apparent to those of ordinary skill in the art by describing in detail exemplary embodiments with reference to the attached drawings in which:

FIG. 1 illustrates an embodiment of a system on chip;

FIG. 2 illustrates an example of internal ROM in FIG. 1;

FIG. 3A illustrates an example of nonvolatile memory device in FIG. 1;

FIG. 3B illustrates another example of a nonvolatile memory device;

FIG. 4 illustrates an example of a boot shell in FIG. 1;

FIG. 5 illustrates a virtual memory controlled by a debug module in FIG. 4;

FIGS. 6A to 6G illustrate diagrams corresponding to an embodiment of a method for driving the system on chip in FIG. 1;

FIG. 7 illustrates a flowchart of an embodiment of a method for driving the system on chip in FIG. 1;

FIG. 8 illustrates another embodiment of a system on chip SOC;

FIG. 9 illustrates an example of an internal ROM in FIG. 8;

FIG. 10A illustrates an example of a nonvolatile memory device in FIG. 8, and FIG. 10B illustrates an example of a nonvolatile memory device;

FIGS. 11A to 11G illustrate diagrams of an embodiment of a method of driving the system on chip in FIG. 8;

FIG. 12 illustrates a flowchart of an embodiment of a method of driving the system on chip in FIG. 8;

FIG. 13 illustrates a main board including the system on chip in FIG. 1;

FIG. 14 illustrates an embodiment of a computer system including the system on chip in FIG. 1;

FIG. 15 illustrates another embodiment of a computer system including the system on chip in FIG. 1; and

FIG. 16 illustrates another embodiment of a computer system including the system on chip in FIG. 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

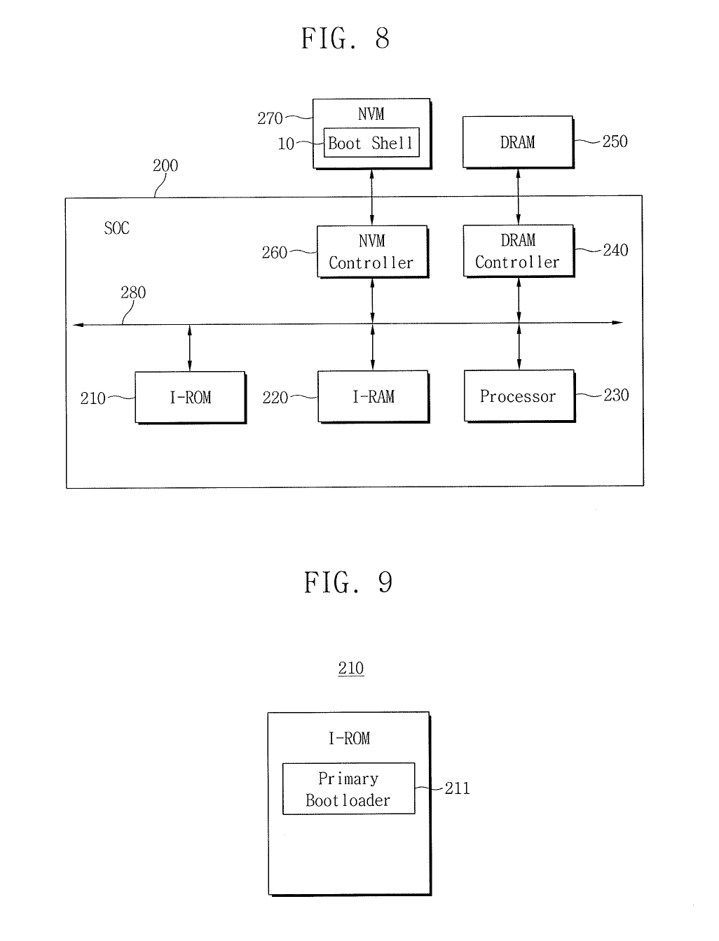

A first exemplary embodiment describes that a boot shell is stored in an internal ROM using FIGS. 1 to 7 in detail. A second exemplary embodiment describes that a boot shell is stored in a nonvolatile memory device using FIGS. 8 to 12 in detail.

FIG. 1 illustrates an embodiment of a system on chip (SOC) 100 which includes an internal ROM 110, an internal RAM 120, and a processor 130. The SOC may be used in any one of a variety of devices including but not limited to smart phones, notebook computers, gaming device, navigation systems, media players, and/or various other types of information terminals which may or may not be portable.

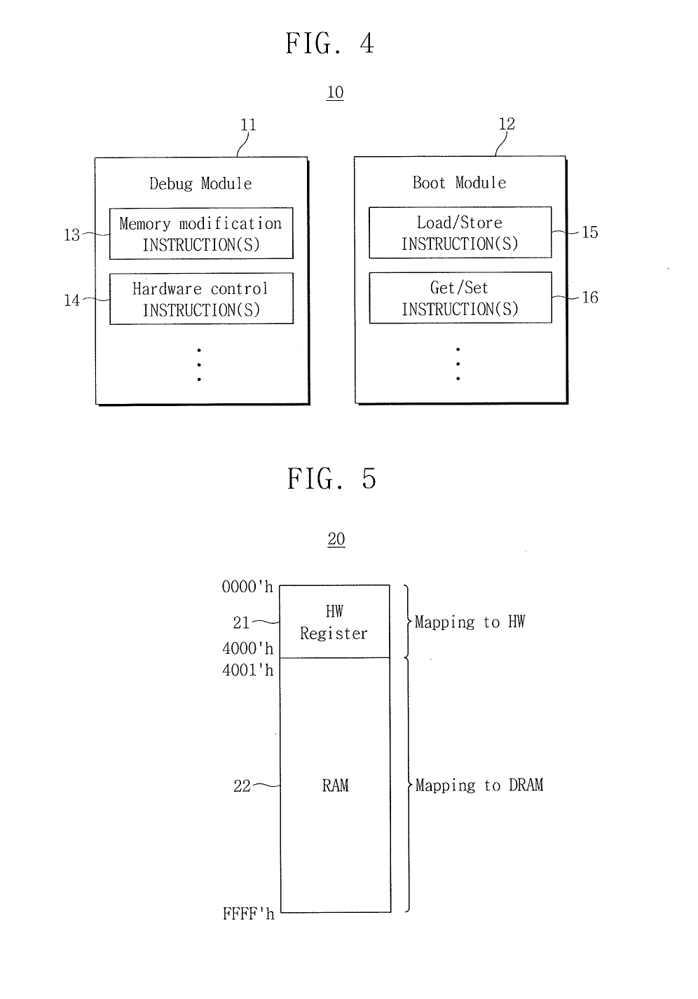

The internal ROM 110 may store information for debugging one or more types of hardware (e.g., a liquid crystal display device, a sound device, an external memory device, etc) and/or may store a boot shell 10 supporting a multi-booting operation. The boot shell 10 may be programmed, for example, during a manufacturing process or may be programmed by a user after manufacture. In one embodiment, the internal ROM 110 may be a kind of a nonvolatile memory device called a mask ROM. In another embodiment, the internal ROM may be a different type of read-only memory, or a writable-type memory may be used in other embodiments. The boot shell 10 may be more thoroughly described with reference to FIG. 4 below.

The internal RAM 120 may temporarily store operating data for the processor 130. The internal RAM 120 may be implemented, for example, as a static random access memory SRAM.

The processor 130 may execute the boot shell 10 stored in the internal ROM 110, and may also access data stored in the internal RAM 120. If the SOC 100 is applied to a mobile device, the processor 130 may be implemented, for example, as an ARM® core.

The SOC 100 may further include a DRAM controller 140 and a nonvolatile memory controller 160. Also, the SOC 100 may include a system bus 180 connecting the internal ROM 110, the internal RAM 120, the processor 130, the DRAM controller 140, and the nonvolatile memory controller 160 mutually.

The DRAM controller 140 may control a DRAM 150. If the processer 130 is operated by 32-bit instructions, the DRAM controller 140 may control the DRAM 150 with a predetermined maximum capacity, e.g., a 4 Gbyte capacity.

The nonvolatile memory controller 160 may control the nonvolatile memory device 170. The nonvolatile memory device 170 may include, for example, a hard disk drive, an optical disk drive, a solid state drive, a multi-media card (MMC), an embedded multi-media card (eMMC), a secure card (SD), etc. In order to support multi-booting, the nonvolatile memory controller 160 may store at least two secondary bootloaders and platforms (hereafter referred to as an “operating system image”) corresponding to the two secondary bootloaders.

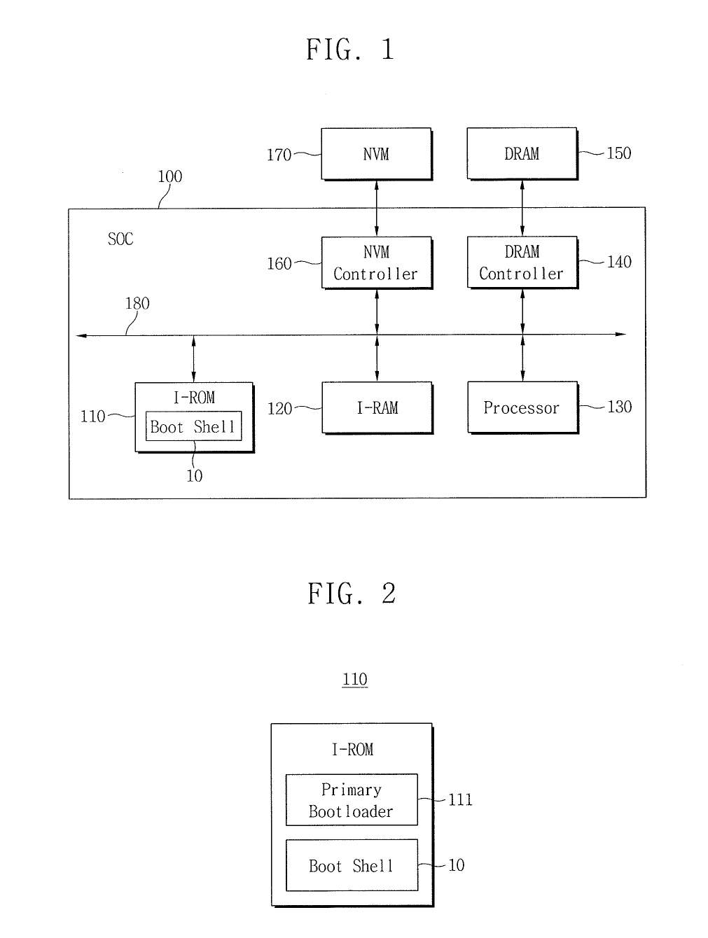

FIG. 2 illustrates an embodiment of the internal ROM 110 shown in FIG. 1. Referring to FIGS. 1 and 2, the internal ROM 110 may store the primary bootloader 111 and the boot shell 10. In order to drive the boot shell 10, the primary bootloader 111 may control hardware that is built inside and outside of the SOC 100 to be initialized. The boot shell 10 may debug and/or verify the initialized hardware, and/or the boot shell 10 may control multi-booting.

The processor 130 may execute the primary bootloader 111 stored in the internal ROM 110. The primary bootloader 111 may control hardware to be initialized. The processor 130 may execute the boot shell 10 stored in the internal ROM 110.

If the boot shell 10 is stored in the internal ROM 110, the boot shell 10 may be executed even if problems regarding hardware of the nonvolatile memory device 170 or the DRAM 150 occurs. For example, even if problems occur at an external device of the SOC 100, no adverse effects are produced because the boot shell 10 is stored in the SOC 100. Accordingly, a booting operation may be successfully executed as long as hardware in the SOC 100 has no problem or at least operates with a predetermined functionality.

Also, when a problem regarding hardware of the nonvolatile memory device 170 and/or the DRAM 150 does occur, execution of the boot shell 10 may identify and/or solve problems regarding the hardware of the nonvolatile memory device 170 or the DRAM 150.

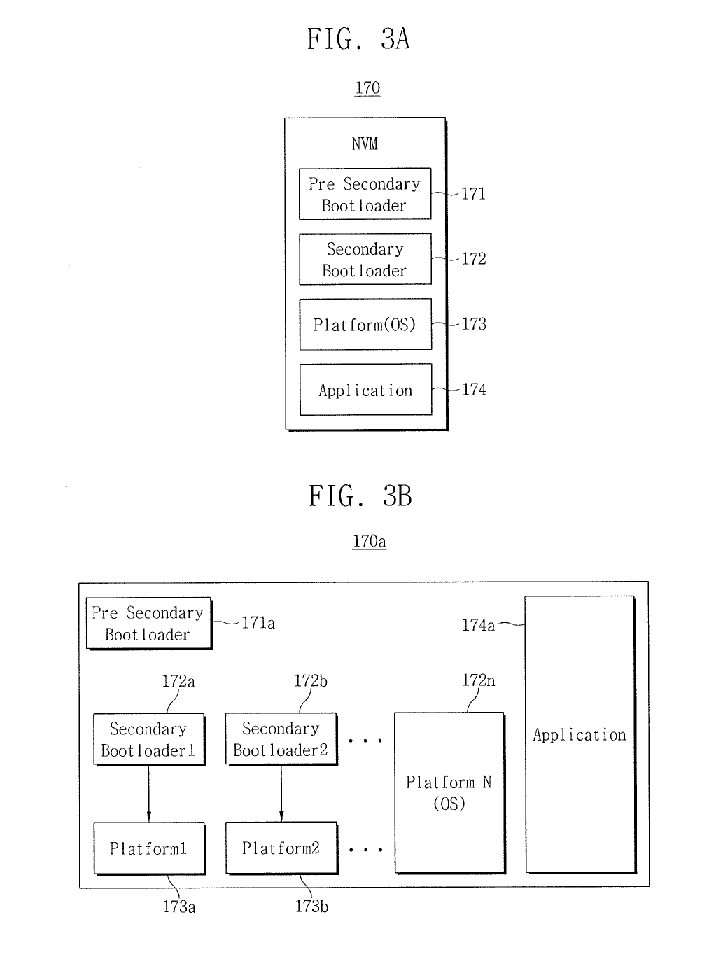

FIG. 3A illustrates an embodiment of the nonvolatile memory device 170. Referring to FIGS. 1 and 3A, the nonvolatile memory device 170 may store a pre-secondary bootloader 171, a secondary bootloader 172, a platform 173, and an application 174.

The pre-secondary bootloader 171 may initialize the DRAM 150. The pre-secondary bootloader 171 may control the processor 130 to load the secondary bootloader 172 to the initialized DRAM 150. In one embodiment, the secondary bootloader 172 controls the processor 130 to load the platform 173, which, for example, may be an operating system, into the initialized DRAM 150. Examples of operating systems which may be loaded include U-boot used in Android®-based devices and BIOS/UEFI used in Windows®- and Linux®-based devices.

The platform 173 may include software for effectively operating hardware including a system such as a computer system, a mobile system, etc. For example, the platform 173 may include Windows®, Linux, and real-time OS, to name a few. The nonvolatile memory device 170 may further include a plurality of operating systems and a plurality of secondary bootloaders for loading the operating systems.

FIG. 3B illustrates an embodiment of a nonvolatile memory device 170 which stores a pre-secondary bootloader 171a, first and second secondary bootloaders 172a and 172b, first and second platforms 173a and 173b, and an application 174a. The platform 173n may be a platform without a secondary bootloader and, for example, may be a real-time OS. In order to support multi-booting, the nonvolatile memory device 170 may include at least two secondary bootloaders and a plurality of platforms responding to them.

If a new mobile system is developed, hardware configured for the new mobile system may need to be verified. However, after the mobile system is loaded, it may be difficult to control directly the hardware of the mobile system. This is because, if an operating system is loaded, a system manager of the operating system may have all authorities on the hardware and identify and may solve a problem by controlling the hardware if the operating system is not loaded.

Accordingly, before the operating system is loaded, a method of debugging the hardware of the mobile system may be needed. A method of debugging hardware using the boot shell 10 before the operating system is loaded is described in FIGS. 4 and 5.

FIG. 4 illustrates an embodiment of the boot shell 10 in FIG. 1. Referring to FIGS. 1 and 4, the boot shell 10 may include a debug module 11 for providing an instruction for verifying hardware and a boot module 12 for supporting multi-booting. More specifically, in one embodiment, the debug module 11 may include a memory modification instruction 13 for changing data stored in the DRAM 150 and a hardware control instruction 14 for controlling a hardware.

The boot module 12 may include a load/store instruction 14 for reading or writing binary data such as the secondary bootloader 172, the platform 173, and the application 174, and a get/set instruction 15 for getting or setting an environment variable to set a booting order for multi-booting.

FIG. 5 illustrates the virtual memory 20 controlled by the debug module 11 shown in FIG. 4. Referring to FIGS. 1, 4, and 5, the virtual memory 20 may include a register 21 for controlling hardware and a random access memory (RAM) 22 for storing data.

The register 21 may be mapped to a register for controlling internal hardware such as the DRAM 150 and/or the nonvolatile memory device 170. The RAM 22 is mapped to the DRAM 150.

The register 21 may store a plurality of setting values. A plurality of setting values may control each of a plurality of hardware devices such as the DRAM 150 and/or the nonvolatile memory device 170. For example, if a setting value stored in the register 21 is changed, hardware may be operated in accordance with the changed setting value.

The hardware control instruction 14 may set each of a plurality of setting values stored in the register 21, e.g., one or more hardware devices may be controlled through the setting value(s) stored in the register 21. The memory modification instruction 13 may change data stored in the DRAM 150. Accordingly, a user may debug hardware using the hardware control instruction 14 and the memory modification instruction 13.

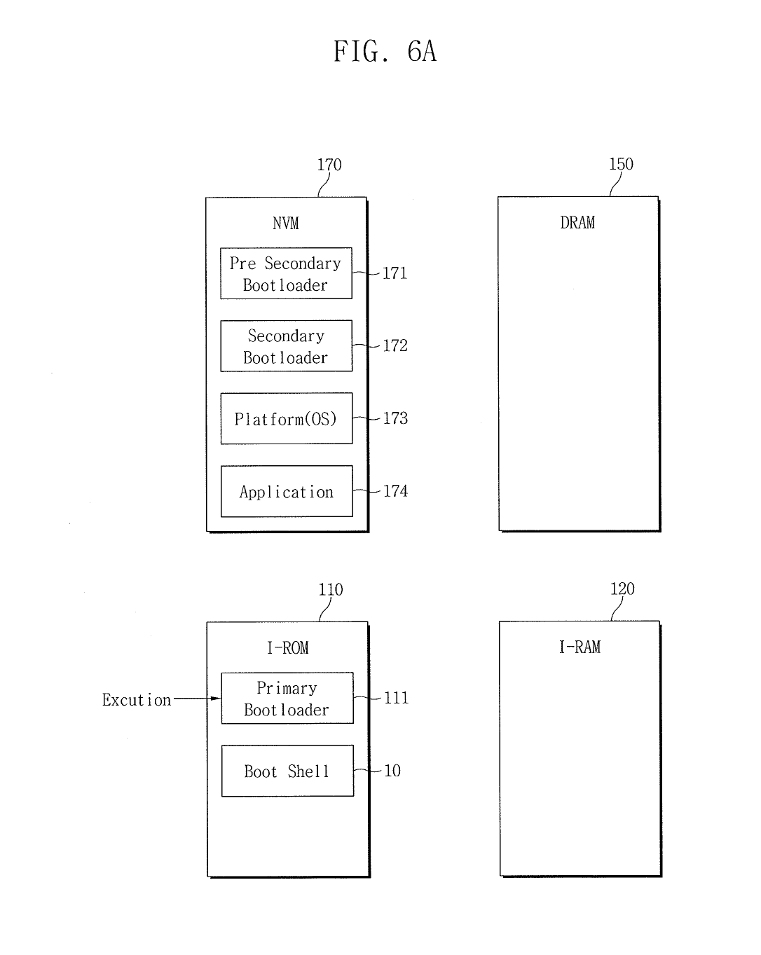

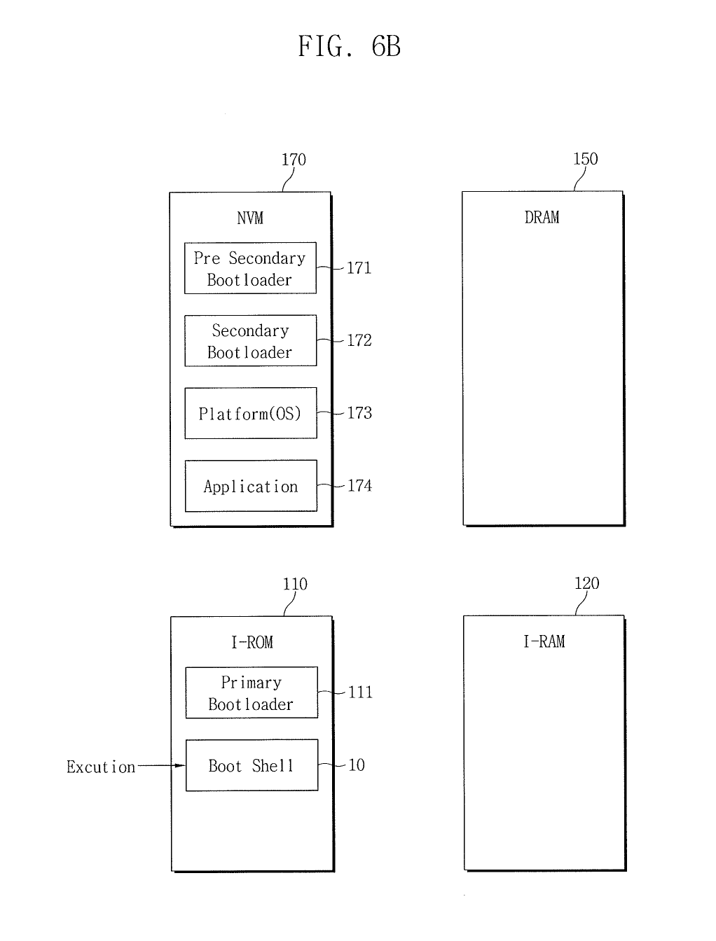

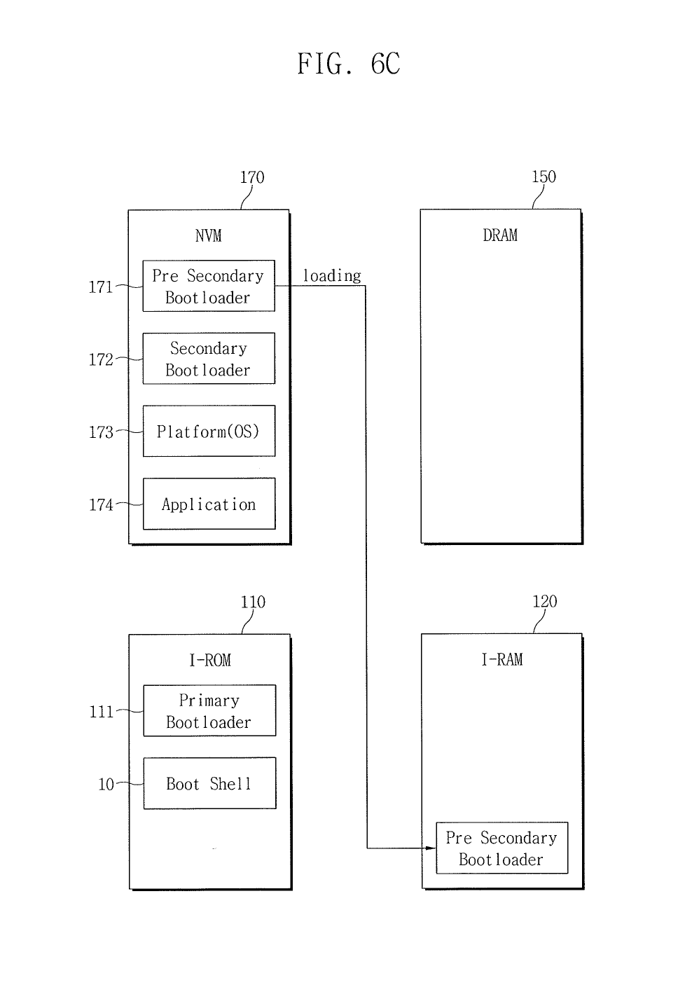

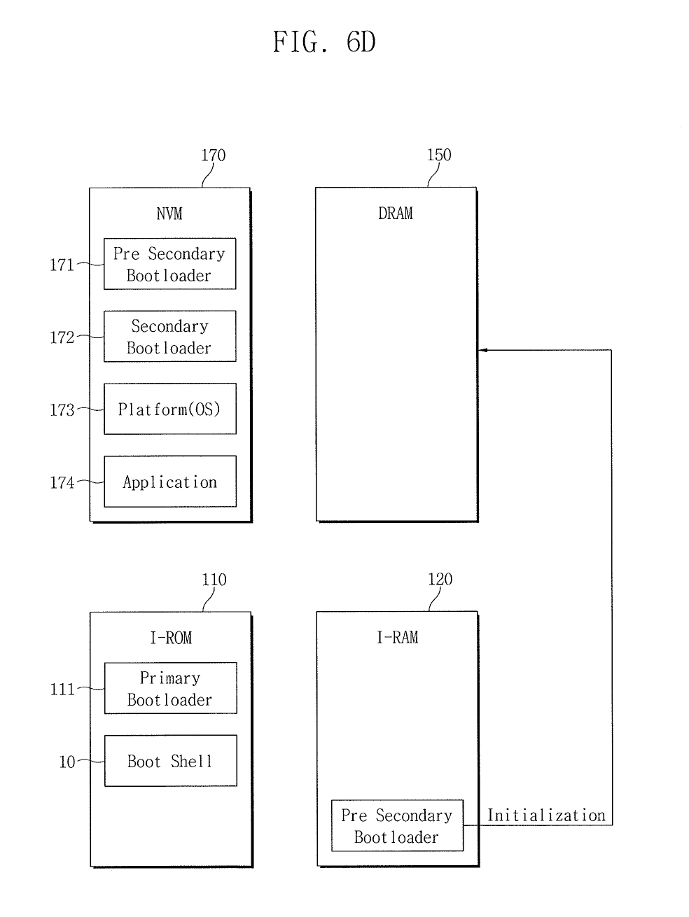

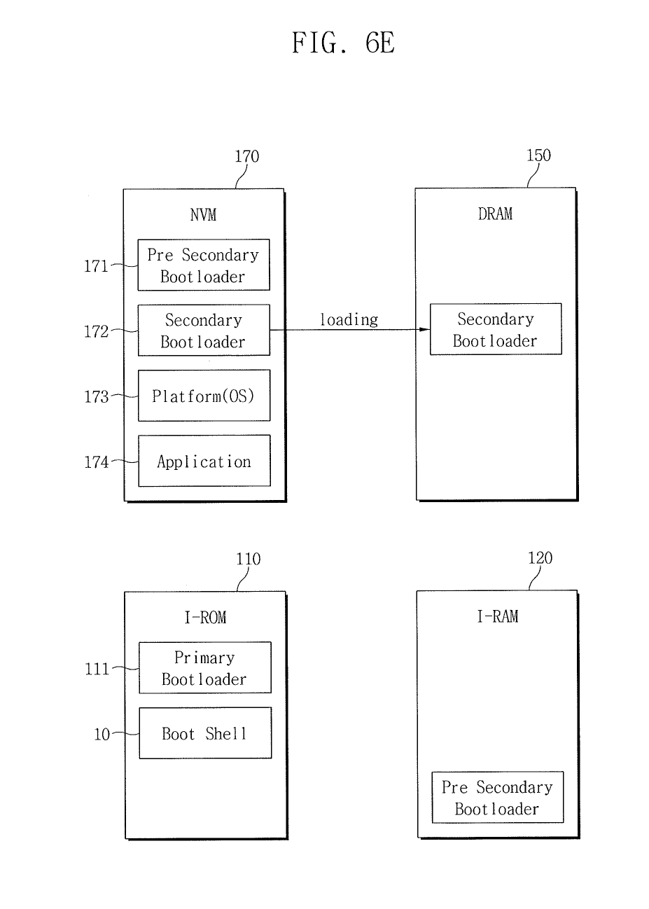

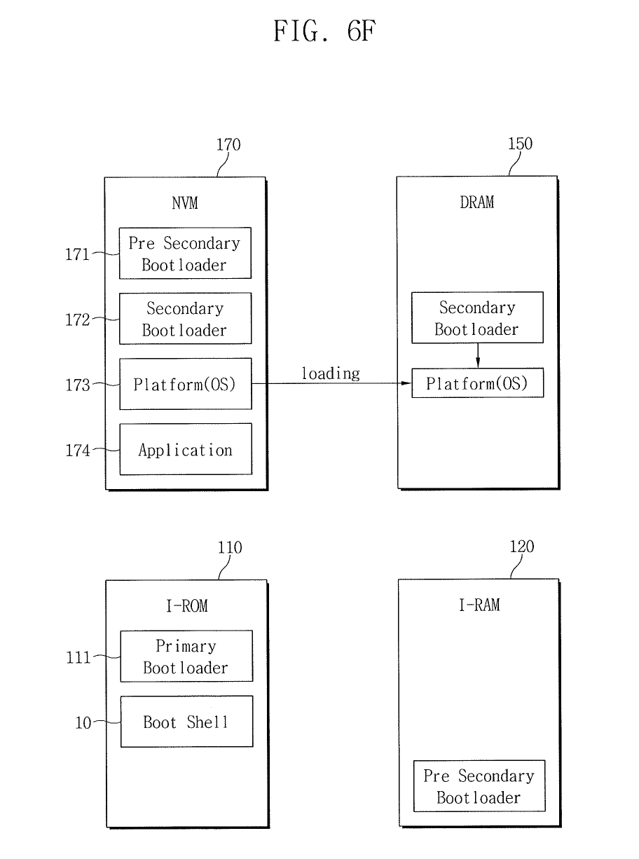

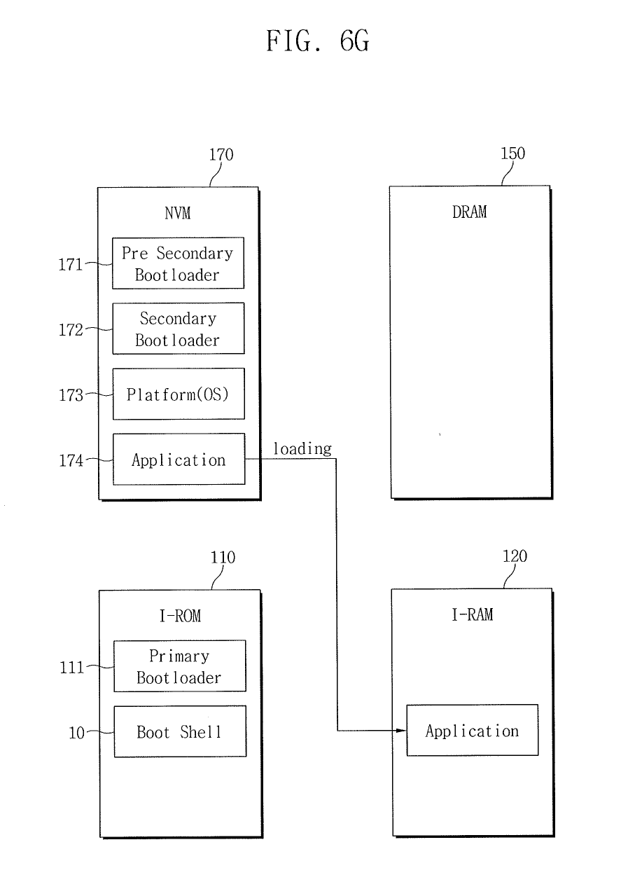

FIGS. 6A to 6G illustrate one embodiment of a method of driving the SOC 100 shown in FIG. 1. Referring to FIG. 6A, the internal ROM 110 may store the primary bootloader 111 and the boot shell 10. The processor 130 may execute the primary bootloader 111 stored in the internal ROM 110, and the primary bootloader 111 may control hardware to be initialized.

Referring to FIG. 6B, the processor 130 may execute the boot shell 10 stored in the internal ROM 110. If the boot shell 10 is executed, a debug mode for verifying one or more hardware devices and/or a booting mode for multi-booting may be selected. For example, when power-on occurs, the SOC 100 may be configured to boot as a default platform. During power-on, when an interrupt signal is generated by a user, the user may select a debug mode or a booting mode selecting one of a plurality of platforms.

Referring to FIG. 6C, the nonvolatile memory device 170 may store a pre-secondary bootloader 171, a secondary bootloader 172, a platform 173, and an application 174. In order to initialize the DRAM 150, the boot shell 10 may control the pre-secondary bootloader 171 stored in the nonvolatile memory device 170 to be transferred to the internal RAM 120.

Referring to FIG. 6D, at power-on, a power or clock for operating the DRAM 150 is not configured at the DRAM 150. Accordingly, first, the DRAM 150 may be initialized in order to load the secondary bootloader 172 and the platform 173. The pre-secondary bootloader 171 may control the DRAM 150 to be initialized.

Referring to FIGS. 6E and 6F, the processor 130 may control the transfer of the secondary bootloader 172 for booting the platform 173 to the DRAM 150. The secondary bootloader 172 may control the platform 173 to be transferred to the DRAM 150.

Referring to FIG. 6G, the processor 130 may transfer the application 174 operated on the boot shell 10 to the internal RAM 120. For example, in order to verify hardware in the SOC 100, if the SOC 100 is in a debug mode, a user may exercise the application 174. For selecting one of the plurality of platforms, if the SOC 100 is in a booting mode, a user may exercise the application 174.

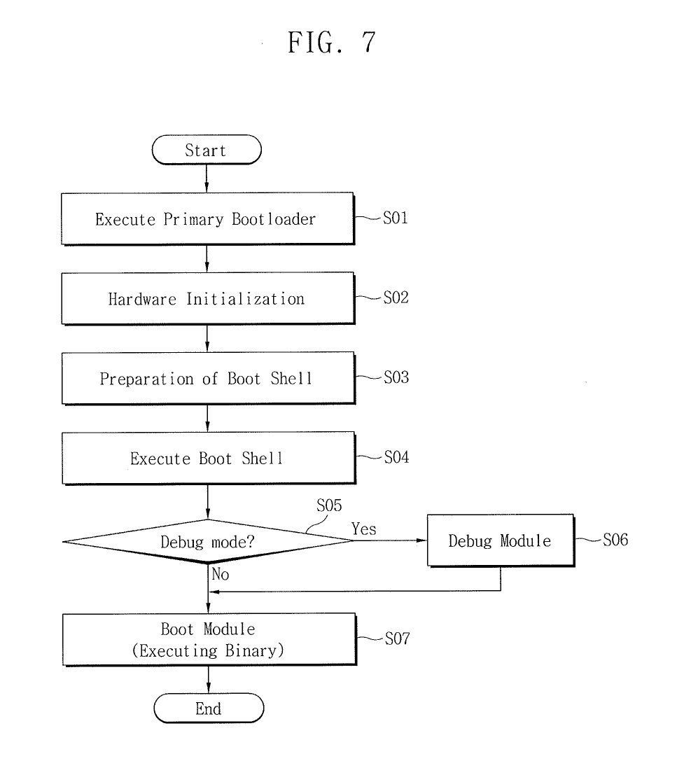

FIG. 7 illustrates a flowchart of a method of driving the SOC 100 shown in FIG. 1. Referring to FIGS. 1 to 7, in operation S01, if a state of the SOC 100 is powered on or reset, the processor 130 may execute the primary bootloader 111 stored in the internal ROM 110.

In operation S02, the primary bootloader 111 may control one or more hardware devices to be initialized. For example, the DRAM 150, the nonvolatile memory device 170, an LCD device, and a sound device may be included in the hardware. Of course, the hardware devices may be different in other embodiments.

In operation S03, the primary bootloader 111 may configure an authority of the boot shell 10 and/or control a booting device to be searched.

In operation S04, in order to debug hardware or support multi-booting, the processor 130 may execute the boot shell 10.

In operation S05, the processor 130 may determine if a current state is a debug mode. If the current state is a debug mode, Step S06 is executed. For example, if the SOC 100 is in a debug mode, a user may execute an instruction for debugging hardware and/or an instruction for supporting multi-booting.

If the current state is a booting mode, operation S07 is executed. For example, if the SOC 100 is in a booting mode, a system including the SOC 100 may execute multi-booting in accordance with an environment setting value, and a user may execute an instruction for multi-booting.

Also, if the SOC 100 is powered on, the SOC 100 may be configured to boot in a default operating system. At this time, if an interrupt occurs, the SOC 100 may be in a debug mode or any other operating system may be selected.

In operation S06, if a current state is a debug mode, a user may utilize an instruction of the debug module 11 in shell mode in order to debug hardware. In accordance with one embodiment, a user may input an instruction interactively and identify a response to the instruction. If a debug mode is terminated, operation S07 is executed.

In operation S07, if the SOC 100 is not in a debug mode or if a debugging operation is terminated, the processor 130 may execute the booting module 12. More specifically, the processor 130 may select an operating system or transfer the secondary bootloader 172 for booting a default operating system to the DRAM 150. Also, the processor 130 may load the platform 173 responding to the secondary bootloader 172. A booting process is then terminated.

In accordance with at least one embodiment, the SOC 100 may therefore verify one or more hardware devices through the boot shell 10 in a unified platform before an operating system is loaded. Also, the SOC 100 may ensure convenience of verification and shorten a verification period.

FIG. 8 illustrates another embodiment of an SOC 200 which includes an internal ROM 210, an internal RAM 220, a processor 230, a DRAM controller 240, and a nonvolatile memory controller 260. The SOC 200 may further include a system bus 280 for connecting the aforementioned components. The DRAM controller 240 may control the DRAM 250. The nonvolatile memory controller 260 may control the nonvolatile memory device 270. The nonvolatile memory device 270 may include a boot shell 10 for debugging hardware and/or supporting multi-booting.

FIG. 9 illustrates an embodiment of the internal ROM 210 in FIG. 8. Referring to FIGS. 8 and 9, the internal ROM 210 may store the primary bootloader 211. The primary bootloader 211 may initialize hardware that is built inside and outside of the SOC 200 and may control the boot shell 10 to be loaded.

The processor 230 may execute the primary bootloader 211 stored in the internal ROM 210. The primary bootloader 211 may control hardware to be initialized in order to provide an environment for executing the boot shell 10. The primary bootloader 211 may control the nonvolatile memory device 270 to load the boot shell 10 to the internal RAM 220. Then, the processor 230 may execute the boot shell 10. The boot shell 10 may be configured, for example, to be identical to the boot shell 10 shown in FIG. 4.

Even though problems occur at the DRAM 250, the boot shell 10 may be executed if the boot shell 10 is stored in the nonvolatile memory device 270. Additionally, when problems occur at hardware of the DRAM 250, the problems regarding the hardware of the DRAM 250 may be identified or solved if the boot shell 10 is executed.

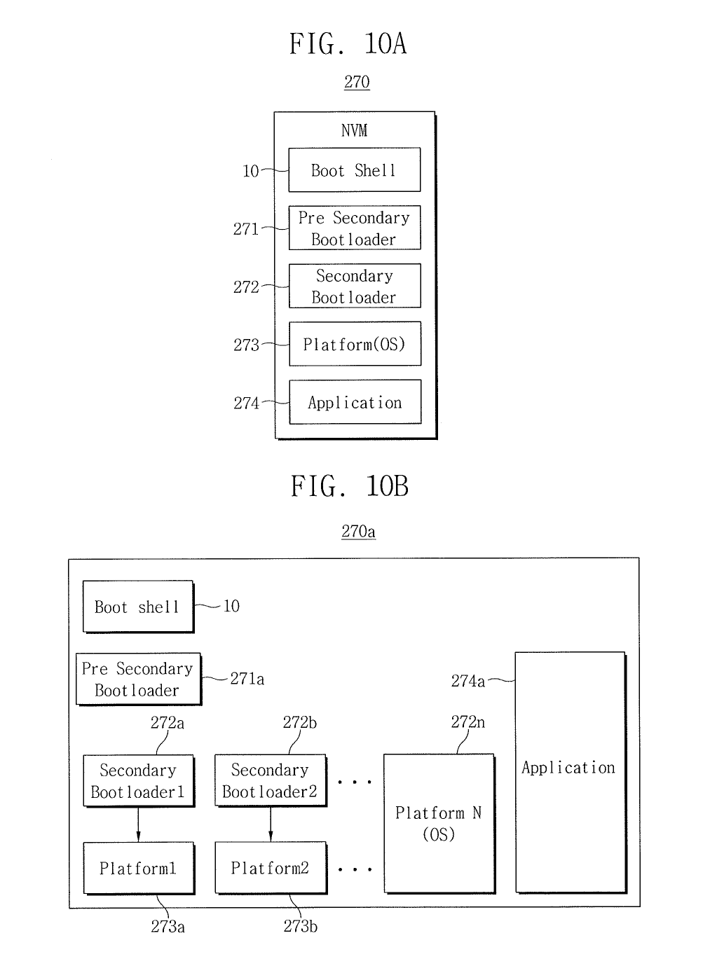

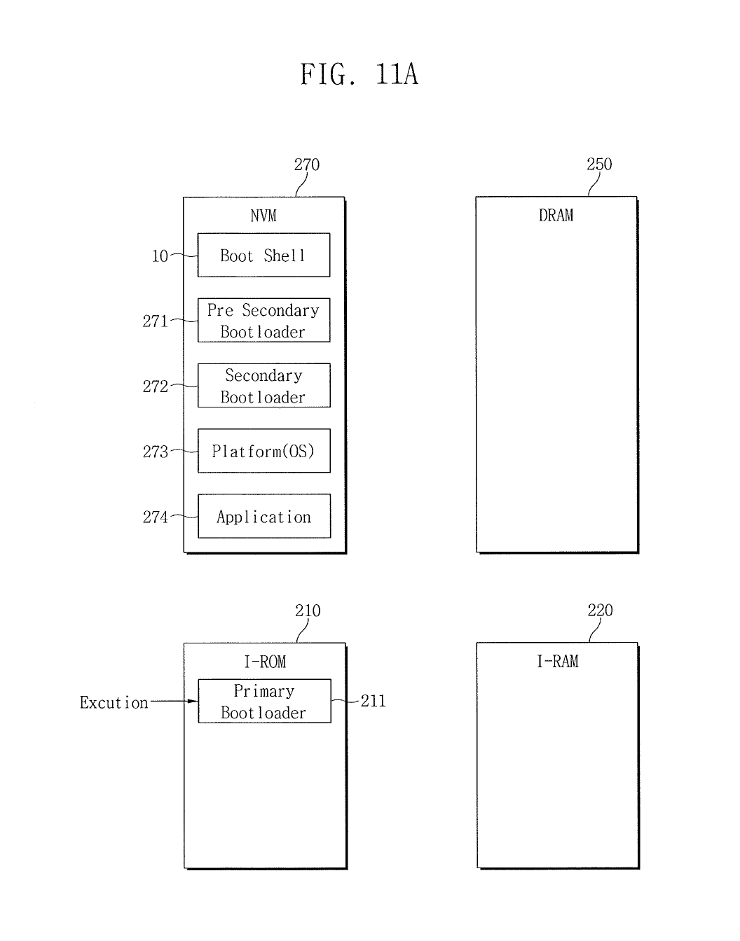

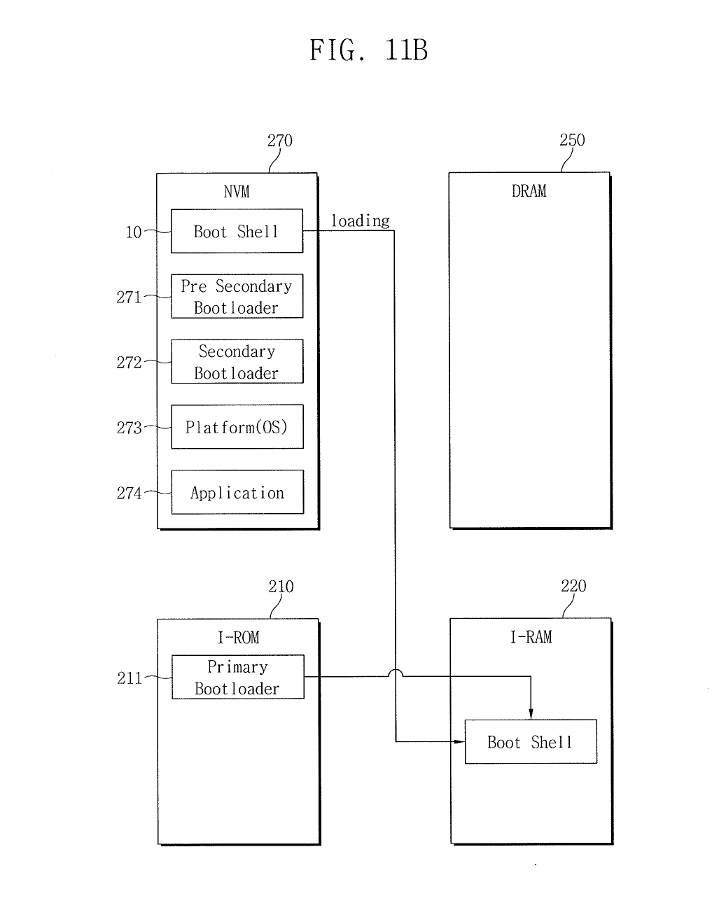

FIG. 10A illustrates an embodiment of the nonvolatile memory device 270 in FIG. 8. Referring to FIGS. 8 and 10A, in this embodiment, the nonvolatile memory device 270 stores the boot shell 10. Also, the nonvolatile memory device 270 stores a pre-secondary bootloader 271, a secondary bootloader 272, a platform 273, and an application 274.

The pre-secondary bootloader 271 may initialize the DRAM 250 and may control the processor 230 to load the secondary bootloader 272 to the initialized DRAM 250. The secondary bootloader 272 may control the processor 230 to load the platform 273, e.g., an operating system. More specifically, the platform 273 may include software for effectively operating one or more hardware devices of the system, such as a computer system, a mobile system, etc. The application 274 may include software executed at the boot shell 10.

The nonvolatile memory device 270 may further include a plurality of operating systems, and a plurality of secondary bootloaders for loading the plurality of operating systems.

FIG. 10B illustrates another embodiment of a nonvolatile memory device 270. Referring to FIGS. 8 and 10B, the nonvolatile memory device 270 may store a pre-secondary bootloader 271a, first and second secondary bootloaders 272a and 272b, first and second platforms 273 and 273b, and an application 274a. The platform 273n may be provided without the secondary bootloader, and also may be, for example, a real-time OS. In order to support multi-booting, the nonvolatile memory device 270 may further include at least two secondary bootloaders and a plurality of platforms responding to them.

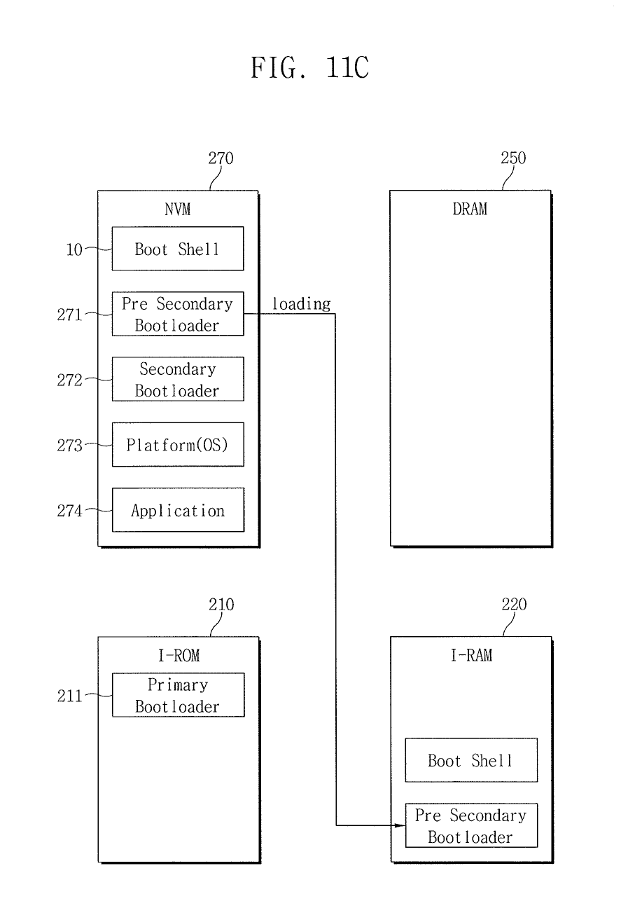

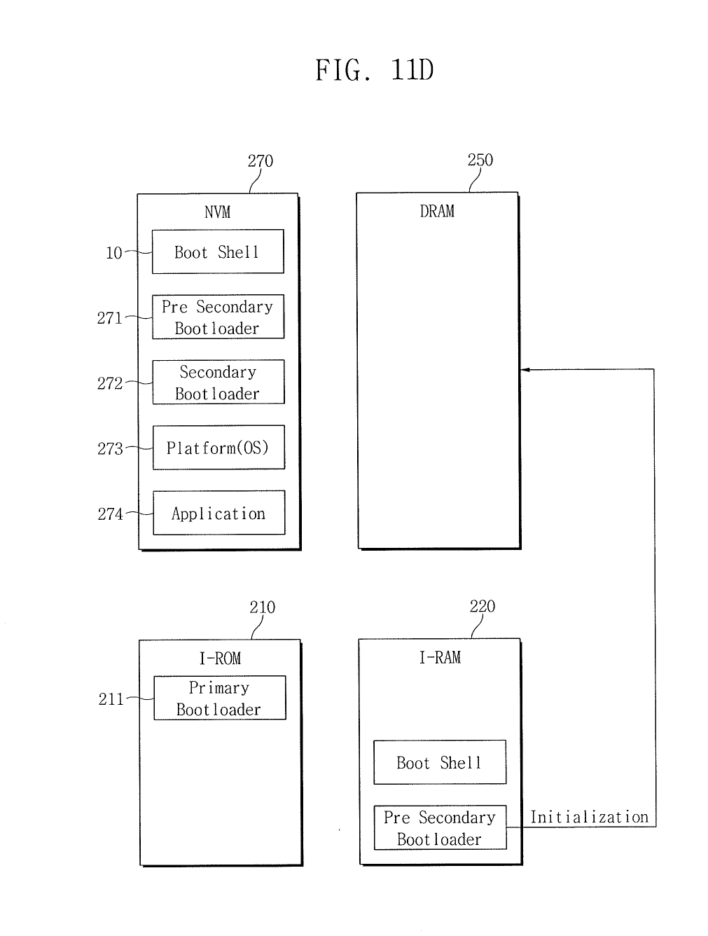

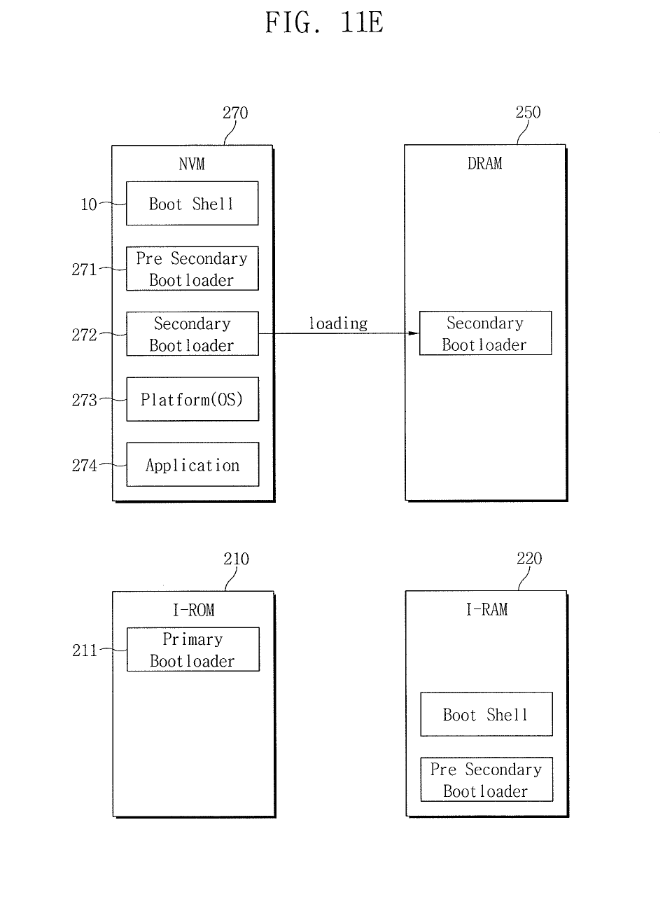

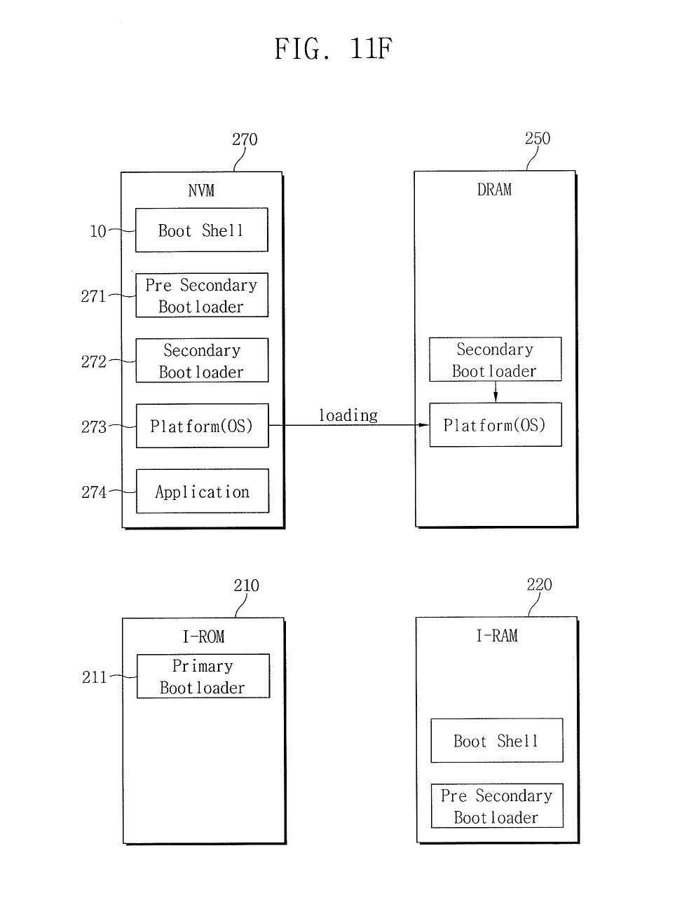

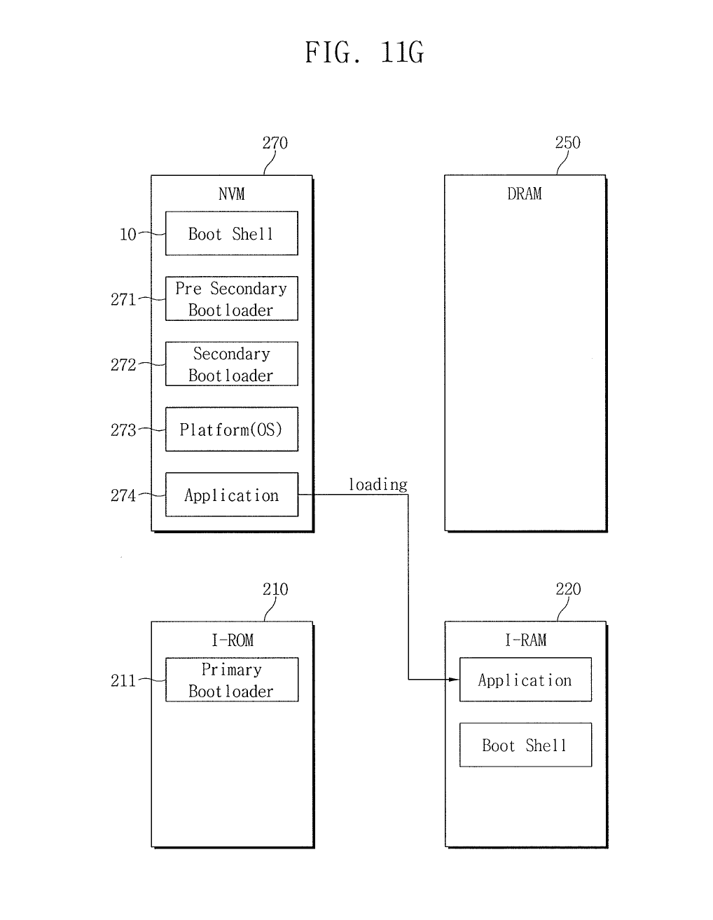

FIGS. 11A to 11G illustrate diagrams illustrating an embodiment of a method of driving SOC 200 in FIG. 8. Referring to FIG. 11A, the internal ROM 210 may store the primary bootloader 211. The processor 230 may execute the primary bootloader 211 stored in the internal ROM 210, and may control hardware to be initialized.

Referring to FIG. 11B, the primary bootloader 211 may control the boot shell 10 stored in the nonvolatile memory device 270 to be transferred to the internal RAM 220. The processor 230 may execute the boot shell 10 stored in the internal RAM 220. If the boot shell 10 is executed, a debug mode for verifying hardware or booting mode for a multi-booting may be selected. For example, when power-on occurs, the SOC 200 may be configured to boot as a default platform. During power-on, when an interrupt signal is generated by a user, the user may select a debug mode or a booting mode selecting one of a plurality of platforms.

Referring to FIG. 11C, the nonvolatile memory device 270 may store a boot shell 10, a pre-secondary bootloader 271, a secondary bootloader 272, a platform 273, and an application 274. In order to initialize the DRAM 250, the boot shell 10 may control the pre-secondary bootloader 271 stored in the nonvolatile memory device 270 to be transferred into the internal RAM 220.

Referring to FIG. 11D, at power-on, a power or clock for operating the DRAM 250 may be not configured at the DRAM 250. Accordingly, firstly, the DRAM 250 may be initialized in order to load the secondary bootloader 272 and the platform 273. The pre-secondary bootloader 271 may control the DRAM 250 to be initialized.

Referring to FIGS. 11E and 11F, the processor 230 may transfer the secondary bootloader 272 for booting in the platform 273 to the DRAM 250. The secondary bootloader 272 may control the platform 273 to be transferred to the DRAM 250.

Referring to FIG. 11G, the processor 230 may transfer the application 274 operated on the boot shell 10 to the internal RAM 220. For example, in order to verify hardware in the SOC 200, if the SOC 200 is in a debug mode, a user may exercise the application 274 in order to verify the hardware. A user may execute the application 274 to selecting one of the plurality of platforms, if the SOC 200 is in a booting mode.

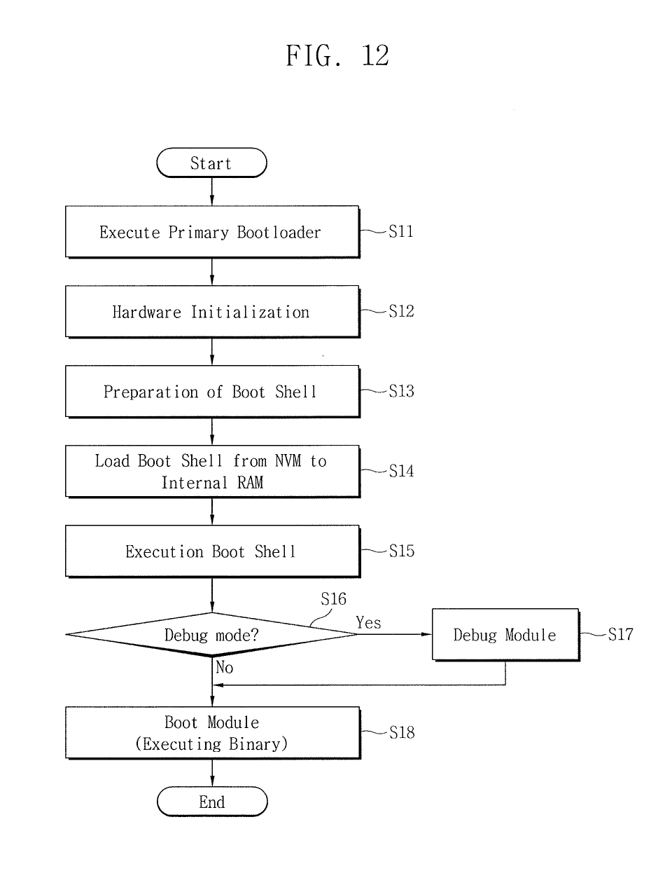

FIG. 12 illustrates a flowchart illustrating an embodiment of a method of driving the SOC 200 in FIG. 8. Referring to FIGS. 8 to 12, in Step S11, if a state of the SOC 200 is powered on or reset, the processor 230 may execute the primary bootloader 211 stored in the internal ROM 210.

In operation S12, the primary bootloader 211 may control hardware to be initialized. The DRAM 250, the nonvolatile memory device 270, an LCD device, and a sound device may be included in the hardware.

In operation S13, the primary bootloader 211 may configure an authority of the boot shell 10 or search a booting device.

In operation S14, the primary bootloader 211 may control the boot shell 10 to be transferred to the internal RAM 220.

In operation S15, in order to debug hardware or support a multi-booting, the processor 230 may execute the boot shell 10.

In operation S16, the processor 230 may determine if a current state is a debug mode. If the current state is a debug mode, operation S17 is executed. If the current state is a booting mode, operation S18 is executed. Also, if the SOC 200 is powered on, the SOC 200 may be configured to boot in a default operating system. If an interrupt occurs, the SOC 200 may be in a debug mode or configured to select any other operating system.

In operation S17, if a current state is a debug mode, a user may interactively execute an instruction of the boot shell 10 in order to debug a hardware. If a debugging operation is terminated, Step S18 step is executed.

In operation S18, if the SOC 100 is not in a debug mode or if a debugging operation is terminated, a current state of the SOC 100 is a booting mode. The processor 230 may load the secondary bootloader 272 and the platform 273 responding to the secondary bootloader 272. A booting process is then terminated.

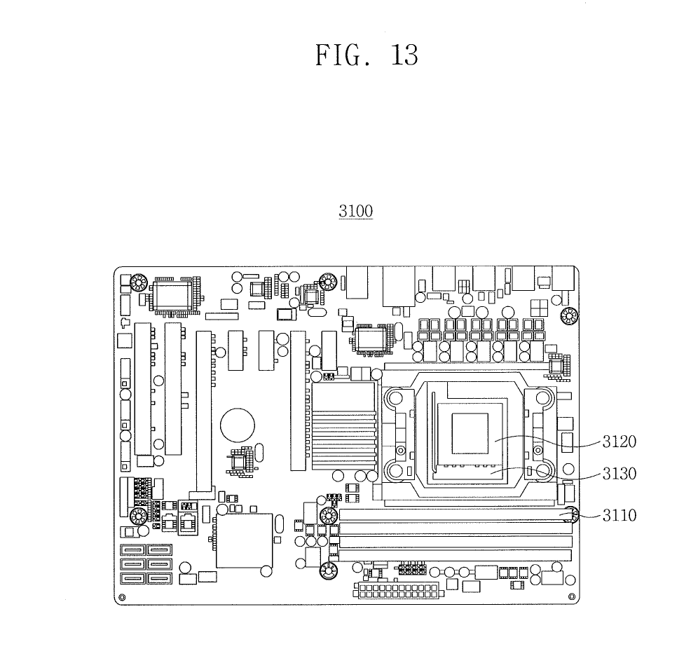

FIG. 13 illustrates an example of a main board 3100 including the SOC 100 shown in FIG. 1. Referring to FIG. 13, the main board 3100 may include a plurality of slots 3110 equipped with a respective number of memory devices, a central processing unit 3120, and a socket 3130 corresponding to the central processing unit 3120. The main board 3100, which, for example, may be a mother board, is physical hardware that includes one or more basic circuits and components in a device, which in this illustrative case is a computer. In an embodiment, the central processing unit 3120 may be implemented as the SOC 100.

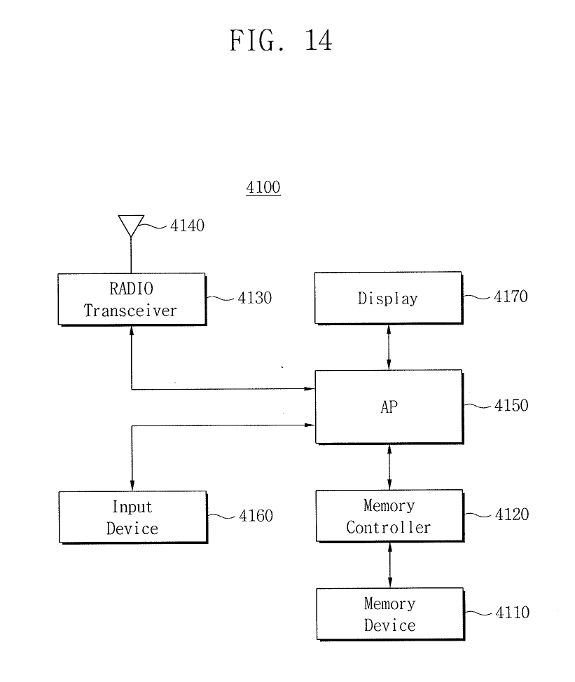

FIG. 14 illustrates an embodiment of a computer system 4100 including the SOC 100 shown in FIG. 1. Referring to FIG. 14, the computer system 4100 may include a semiconductor memory device 4110, a memory controller 4120 for controlling the semiconductor memory device 4110, a wireless transmitter-receiver 4130, an antenna 4140, an application processor 4150, an input device 4160, and a display device 4170.

The wireless transmitter-receiver 4130 may transmit and receive wireless signals through the antenna 4140. For example, the wireless transmitter-receiver 4130 may modulate wireless signals to signals to be processed by the application processor 4150.

The application processor 4150 may process signals output from the wireless transmitter-receiver 4130 and transfer the processed signal to display device 4170. In one embodiment, the application processor 4150 may be implemented as the SOC 100 shown in FIG. 1.

The wireless transmitter-receiver 4130 may modulate the signal output from the application processor 4150 to wireless signals and output the modulated wireless signals through the antenna 4140 to an external device (e.g., a host).

The input device 4160 is a device capable of inputting a control signal for controlling an operation of the application processor 4150 and/or data operated by the application processor 4150. Examples of the input device 4160 include but are not limited to a touch pad, a keypad, a keyboard, and a pointing device such as a computer mouse.

The memory controller 4120 may control an operation of the semiconductor memory device 4110 and may be implemented, for example, as a part of the application processor 4150 or as a separate chip different from the application processor 4150.

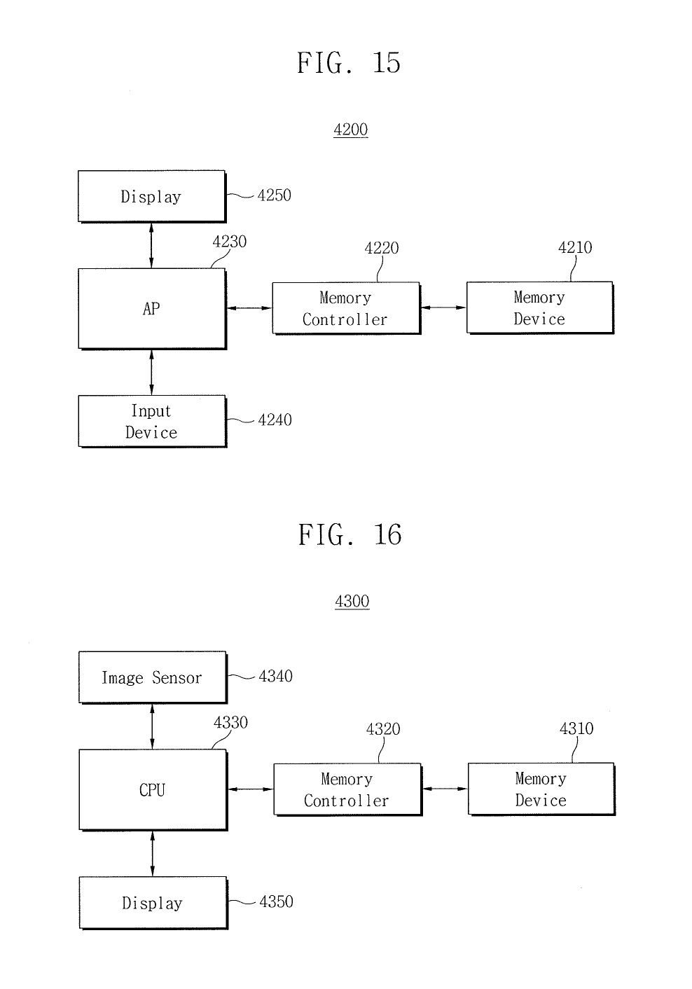

FIG. 15 illustrates another embodiment of a computer system 4200 including the

SOC 100 shown in FIG. 1. Referring to FIG. 15, the computer system 4200 may be implemented, for example, as a personal computer (PC), a network server, a tablet PC, a net-book, an e-reader, a personal digital assistant (PDA), a portable multimedia player (PMP), a MP3 player, or a MP4 player, or any one of a number of other devices for processing and/or outputting information.

The computer system 4200 may include a semiconductor memory device 4210, a memory controller 4220 controlling the semiconductor memory device 4210, an application processor 4230, an input device 4240, and a display device 4250.

The application processor 4230 may display data stored in the semiconductor memory device 4210 through the display device 4250. For example, the input device 4240 may be implemented as a touch pad, a keypad, a keyboard, or a pointing device such as a computer mouse. The application processor 4230 may control an entire operation of the computer system 4200 and control an operation of the memory controller 4220. In an embodiment, the application processor 4230 may be implemented as the SOC 100 shown in FIG. 1.

In an embodiment, the memory controller 4220 capable of controlling an operation of the semiconductor memory device 4210 may be implemented as a part of the application processor 4230 or as a separate chip different from the application processor 4230.

FIG. 16 illustrates another embodiment of a computer system 4300 including the

SOC 100 shown in FIG. 1. Referring to FIG. 16, the computer system 4300 may be implemented as an image process device such as, for example, a digital camera, a mobile telephone equipped with a digital camera, a smart phone, or tablet PC.

The computer system 4300 may include a semiconductor memory device 4310 and a memory controller 4320 controlling data processing operation of the semiconductor memory device 4310 such as writing/reading. The computer system 4300 may further include a central processing unit 4330, an image sensor 4340, and a display device 4350.

The image sensor 4340 may convert an optical image to a digital signal and transfer the converted digital signal to central processing unit 4330 or the memory controller 4320. As a control of the central processing unit 4330, the converted digital signal may be displayed through the display device 4350 or stored in the semiconductor memory device 4310 through the memory controller 4320.

Additionally, data stored in the semiconductor memory device 4310 may be outputted through display device 4350 in response to the central processing unit 4330 or the memory controller 4320. In an embodiment, the central processing unit 4330 may be implemented as the SOC 100 shown in FIG. 1.

In an embodiment, the memory controller 4320 capable of controlling an operation of the semiconductor memory device 4310 may be implemented as a part of the central processing unit 4330 or as a separate chip different from the central processing unit 4330.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A system on chip (SOC), comprising:
a first memory configured to store a primary bootloader for providing an environment in which a boot shell is to be executed; and
a processor configured to execute the primary bootloader to initialize hardware, wherein the boot shell includes at least one instruction for debugging the hardware, and wherein the processor executes the boot shell and debugs the hardware before a platform is loaded.

2. The SOC as claimed in claim 1, further comprising:
a first controller configured to control a second memory; and
a second controller configured to control a nonvolatile memory device,
wherein the boot shell is stored in one of the first memory or the nonvolatile memory device, and wherein the nonvolatile memory device stores a pre-secondary bootloader, a plurality of secondary bootloaders, a plurality of platforms corresponding to respective ones of the secondary bootloaders, and an application.

3. The SOC as claimed in claim 2, wherein:
if the boot shell is stored in the first memory, the boot shell is executed at the first memory, and
if the boot shell is stored in the nonvolatile memory device, the boot shell is transferred to the first memory and is executed at the first memory.

4. The SOC as claimed in claim 2, wherein the at least one instruction for debugging the hardware includes an instruction for changing data stored in the second memory and an instruction for controlling the hardware.

5. The SOC as claimed in claim 2, wherein the nonvolatile memory device includes a hard disk drive (HDD), an optical disk drive (ODD), a solid state drive (SSD), a multi-media card (MMC), an embedded multi-media card (eMMC), or a secure digital card.

6. The SOC as claimed in claim 2, wherein the pre-secondary bootloader initializes the second memory and controls the secondary bootloader to be loaded to the second memory.

7. The SOC as claimed in claim 6, wherein the secondary bootloader controls the platform to be loaded to the second memory.

8. The SOC as claimed in claim 2, wherein the boot shell further includes at least one instruction for supporting multi-booting, the instruction for supporting multi-booting including a load/store instruction to read or write at least one of the secondary bootloader, the platform, or the application, and a get/set instruction to load or set an environment variable for setting multi-booting.

9. The SOC as claimed in claim 2, wherein the hardware includes at least one of the second memory, the nonvolatile memory device, a display device, or a sound device.

10. The SOC as claimed in claim 2, wherein the platform includes at least one type of operating system.

11. A system on chip, comprising:
a first memory to store a primary bootloader and a boot shell; and
a processor to initialize an off-chip hardware device by:
(a) executing the primary bootloader to control an authority of the boot shell or to locate a booting device, and
(b) executing at least one instruction in the bootshell to debug the off-chip hardware or to perform a multibooting operation before loading of an operating system.

12. The system on chip as claimed in claim 11, wherein:
the bootshell includes at least one instruction to be executed in a first mode and at least one instruction to be executed in a second mode, and
the processor executes the at least one instruction in the first mode to debug the off-chip hardware before an operating system is loaded.

13. The system on chip as claimed in claim 12, wherein the second mode is a boot mode.

14. The system on chip as claimed in claim 12, wherein the processor changes from the second mode as a default mode to the first mode based on a user input.

15. The system on chip as claimed in claim 11, further comprising:
a second memory to store a pre-secondary bootloader received from an off-chip source, wherein the processor executes the pre-secondary bootloader to control transfer of a secondary bootloader from the off-chip source to the second memory for initializing the off-chip hardware, and wherein the second memory receives an application from the off-chip source to verify the off-chip hardware after transfer of the secondary bootloader into the second memory.

16. A method of driving a system on chip, the method comprising:
executing a primary bootloader to initialize hardware;
executing a boot shell;
determining whether a current state is a debug mode; and
debugging the hardware if the current state is the debug mode, wherein the boot shell stores at least one instruction for debugging the hardware.

17. The method as claimed in claim 16, further comprising:
setting an authority of the boot shell; and
searching for a booting device.

18. The method as claimed in claim 16, wherein debugging includes:
executing at least one instruction to adjust a setting value to control an operation of the hardware.

19. The method as claimed in claim 16, further comprising:
executing a multi-booting operation if the current state is not the debug mode.

20. The method as claimed in claim 19, wherein executing the multi-booting operation includes executing a load/store instruction to read or write one of the secondary bootloader, the platform, or the application, and a get/set instruction to load or set an environment variable for setting the multi-booting operation.
